(19) United States
(12) Patent Application Publication
(10) Pub. No.: US 2010/0201737 A1
(43) Pub. Date: Aug. 12, 2010

(54) INK SET AND IMAGE RECORDING METHOD

(75) Inventor: Toshihiro Kariya, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, MINATO-KU (JP)

(21) Appl. No.: 12/762,761

(22) Filed: Apr. 19, 2010

Related U.S. Application Data
(62) Division of application No. 12/400,933, filed on Mar. 10, 2009.

(30) Foreign Application Priority Data
Mar. 13, 2008 (JP) 2008-064546

(51) Int. Cl. B41J 2/015

(52) U.S. Cl. 347/21

(57) ABSTRACT

The invention provides an ink set including: an ink composition which contains a colorant, resin microparticles, a water-soluble organic solvent, and water; and a reaction liquid which contains an anionic surfactant and a reactant for producing aggregates by contact with the ink composition. The invention also provides an image recording method using the ink set, including: applying the reaction liquid on a recording medium; and applying the ink composition on the recording medium on which the reaction liquid has been applied.

### CROSS-REFERENCE TO RELATED APPLICATION

This application is a Divisional of U.S. application Ser. No. 12/400,933, filed Mar. 10, 2009, which claims priority under 35 USC 119 from Japanese Patent Application No. 2008-064546, the disclosures of which are incorporated by reference herein.

### BACKGROUND OF THE INVENTION

1. Field of the Invention

The present invention relates to an ink set and an image recording method.

2. Description of the Related Art

In recent years, various methods for recording color images have been proposed as image recording methods. However, every method is facing with ever-increasing demands for higher grade of recording products such as image quality, feeling, and after-recording curl prevention.

Among them, in the field of commercial printing, a printing texture such as that of printing paper for general use is required, as opposed to a surface such as that of a photograph that completely shuts out penetration of ink solvent into the base paper.

In commercial printing, printed sheets are required to have an appearance similar to that of general printing paper, rather than a surface, such as that of a photograph, that completely blocks penetration of ink solvent into base paper. However, the range of properties such as surface gloss, texture and stiffness is limited when a recording medium has a solvent absorption layer with a thickness as large as from 20 μm to 30 μm. Therefore, application of inkjet techniques in commercial printing has been limited, for example, to posters and vouchers, with respect to which the restrictions on surface gloss, texture, stiffness and the like are tolerable.

An inkjet recording method for forming high-quality images by preparing a liquid composition (reaction liquid) for making images better, separately from common inkjet ink, and applying the liquid composition on a recording medium in advance of ejecting a recording ink to form images has been variously proposed (see, for example, Japanese Patent Application Laid-Open “JP-A” Nos. 9-207424 and 2006-188045).

On the other hand, a technique of containing a surfactant in a penetrant liquid for facilitating penetration of an ink solvent into a recording medium (see, for example, Japanese Patent “JP” No. 3667160), a technique of applying a cationic surfactant as an ink aggregation liquid (see, for example, in JP-A No. 9-248920), and a technique of preventing bleeding between colors by using a silicon surfactant or a fluoric surfactant (see, for example, in JP-A No. 2004-338392) are known.

However, in the image forming methods disclosed in JP-A Nos. 9-207424 and 2006-188045, a recording process is performed such that a pigment ink is applied after applying the reaction liquid on the surface of the recording medium so as to mix with the reaction liquid on the recording medium in their liquid state, accordingly deterioration of image fixativity and paper deformation such as curl and cockle of the recording media may become obvious that had not occurred when images were formed using only pigment ink. Such paper deformation may cause paper jam, displacement of ink spotting points leading to deterioration in image quality, and contacts with inkjet heads leading to stains on the recording surface.

The surfactants used for the penetrant liquids or ink aggregation liquids in the methods disclosed in JP No. 3667160, JP-A Nos. 9-248920 and 2004-338392 were intended for mainly adjusting surface tension, and they could not prevent paper deformation such as curl and cockle of the recording media.

### SUMMARY OF THE INVENTION

The present invention has been made in view of the above circumstances and provides an ink set and image recording method. A first aspect of the present invention provides an ink set comprising: an ink composition which comprises a colorant, resin microparticles, a water-soluble organic solvent, and water; and

a reaction liquid which comprises an anionic surfactant and a reactant for producing aggregates by contact with the ink composition.

A second aspect of the present invention provides an image recording method for forming an image using a colored ink composition, the method comprising: applying, on a recording medium, a reaction liquid, which comprises an anionic surfactant and a reactant for producing aggregates by contact with the ink composition; and applying, on the recording medium on which the reaction liquid has been applied, the ink composition, which comprises a colorant, resin microparticles, a water-soluble organic solvent, and water.

### DETAILED DESCRIPTION OF THE INVENTION

### Ink Set

The ink set according to an aspect of the invention includes a reaction liquid which contains a reactant for producing aggregates by contacting with an ink composition and at least one anionic surfactant; and at least one ink composition which contains a colorant, resin microparticles, a water-soluble organic solvent, and water. Since the reaction liquid contains an anionic surfactant, occurrence of curl and cockle can be inhibited effectively even when image recording is performed using general-purpose printing paper as an recording medium, and therefore image recording where occurrence of bleeding is inhibited can be achieved.

<Reaction Liquid>

The reaction liquid according to an aspect of the invention includes at least one reactant for producing aggregates by contacting with an ink composition and at least one anionic surfactant, and further may include a water-soluble organic solvent, water, and other additives, if necessary.

(Anionic Surfactant)

The reaction liquid according to an aspect of the invention includes at least one anionic surfactant.

The above-described anionic surfactant means a compound having an anionic site in the molecule and is active in surface activity. The anionic site is not particularly limited as long as the site is a group which can be dissociated to an anion. Examples of such a group include a sulfonamide group, a sulfo group, a carboxyl group, a phosphoric acid group, and a phosphonic acid group. Among them, a carboxyl group or a phosphoric acid group is preferable from the viewpoint of adsorptivity to a recording medium (e.g., paper).

Although the anionic surfactant according to an aspect of the invention may be either a fluorine anionic surfactant having a fluorine atom in the molecule or a non-fluorine anionic surfactant having no fluorine atom in the molecule, a fluorine anionic surfactant is preferable from the viewpoint of occurrence inhibition of curl and cockle.

Examples of the non-fluorine anionic surfactant include a fatty acid salt, alkyl sulfate, alkylbenzene sulfonate, alkylnaphthalene sulfonate, dialkyl sulfosuccinate, alkyl phosphate, a naphthalene sulfonic acid formalin condensate, and polyoxyethylenealkyl sulfate salt.

The non-fluorine anionic surfactant according to an aspect of the invention is preferably alkane sulfonate, N-acyl glutamate, or alkyl phosphate; and more preferably alkylbenzene sulfonate, or dialkyl sulfosuccinate, from the viewpoint of occurrence inhibition of curl and cockle.

Although the fluorine anionic surfactant preferably used according to an aspect of the invention is not particularly limited as long as the surfactant is a compound having an anionic group and a substituent having a fluorine atom in the molecule, and is active in surface activity, the fluorine anionic surfactant is preferably represented by the following formula (1), from the viewpoint of occurrence inhibition of curl and cockle.

(Cf)-(Y)ₙ: formula (1)

In the formula, Cf represents a n-valence group having at least three fluorine atoms and at least two carbon atoms, Y represents —COO⁻M⁺, —SO₃⁻M⁺, —OSO₃⁻M⁺, or —OP(═O)(O⁻M⁺)₂. M⁺ represents a hydrogen ion or a cation, and n is 1 or 2.

The fluorine anionic surfactant according to an aspect of the invention is more preferably represented by the following formula (2).

Rf-(D)ₜ-Y: formula (2)

In the formula, Rf represents a fluorine-substituted alkyl group or a fluorine-substituted aryl group having 3 to 30 carbon atoms, D represents a divalent group having 1 to 12 carbon atoms single bonded containing at least one selected from the connecting groups consisting of —O—, —COO—, —CON(R₁)—, —SO₂N(R₁)—, and —S—. R₁ represents an alkyl group having 1 to 5 carbon atoms, and t is 1 or 2.

Y represents —COO⁻M⁺, —SO₃⁻M⁺, —OSO₃⁻M⁺, or —OP(═O)(O⁻M⁺)₂, where M⁺ represents a hydrogen ion or a cation.

In the above formula (1) or formula (2), M⁺ represents a hydrogen ion or a cation. The cation is preferably, an ammonium ion or a metal cation, more preferably an ammonium ion or a monovalent metal cation, and particularly preferably an ammonium ion, a lithium ion, a sodium ion, or a potassium ion.

In the formula (2), Rf is preferably a fluorine-substituted alkyl group having 3 to 16 carbon atoms, and more preferably a perfluoroalkyl group having 3 to 16 carbon atoms, from the viewpoint of occurrence inhibition of curl and cockle.

Further, in formula (2), D is preferably a divalent group having 2 to 6 carbon atoms single bonded containing at least one selected from —O— and —S—.

Specific examples of the fluorine anionic surfactant according to an aspect of the invention include that of a ZONYL series (trade name for a fluorine anionic surfactant, manufactured by E. I. du Pont de Nemours and Company) and that of a FLUORAD series (trade name for a fluorine anionic surfactant, manufactured by 3M Company).

Examples of the ZONYL series fluorine anionic surfactants desirably include the following.

ZONYL FSP: (RF—CH₂CH₂O)ₓPO(O⁻NH₄⁺)_{y}, where, x+y=3,

ZONYL FSJ: FSP+a hydrocarbon-containing surfactant,

ZONYL UR: (RF—CH₂CH₂O)ₓPO(OH)_{y}, where, x+y=3,

ZONYL TBS: RF—CH₂CH₂SO₃H, RF—CH₂ CH₂SO₃⁻NH₄⁺,

ZONYL FS-62: C₆F₁₃CH₂CH₂SO₃H, C₆F₁₃CH₂CH₂SO₃⁻NH₄⁺, and

ZONYL FSE: (RF—CH₂CH₂O)ₓPO(O⁻NH₄⁺)_{y}(OCH₂CH₂OH)_{z}, where, x+y+z=3,

wherein, the site RF is F(CF₂CF₂)_{z}, and z=1 to 7 (FSP, FSJ, UR, and FSE) or 1 to 9 (TBS).

Examples of the FLUORAD series fluoro surfactants include ammonium perfluoroalkyl sulfonates (FC-120), fluorinated potassium alkyl carboxylates (FC-129), fluorinated alkyl polyoxylene ethanols (FC-170C), fluorinated alkyl alkoxylates (FC-171), and fluorinated alkyl ethers (FC-430, FC-431, and FC-470).

According to an aspect of the invention, the above anionic surfactants may be used either singly or in a combination of two or more.

The content ratio of the anionic surfactant in the reaction liquid is not particularly limited, for example, it may be 0.1 to 10 mass %, preferably 0.5 to 7.0 mass %, and more preferably 1.0 to 5.0 mass %, from the viewpoint of applicability of the reaction liquid.

(Reactant)

The reactant described above is not particularly limited as long as the reactant is capable of producing aggregates by contacting with an ink composition, and that may be any of a compound which is capable of changing pH of the ink composition, a polyvalent metal salt, and a polyallylamine. According to an aspect of the invention, a compound which is capable of changing pH of the ink composition is preferable and a compound which is capable of lowering pH of the ink composition is more preferable, from the viewpoint of aggregability of the ink composition.

Examples of the compound which is capable of lowering pH of the ink composition include an acidic substance, and that is preferably selected from a phosphoric acid, a polyacrylic acid, an acetic acid, a glycolic acid, a malonic acid, a malic acid, a maleic acid, an ascorbic acid, a succinic acid, a glutaric acid, a fumaric acid, a citric acid, a tartaric acid, a lactic acid, a sulphonic acid, an orthophosphoric acid, a pyrrolidone carboxylic acid, a pyrone carboxylic acid, a pyrrole carboxylic acid, a furan carboxylic acid, a pyridine carboxylic acid, a coumaric acid, a thiophene carboxylic acid, and a nicotinic acid; or a derivative selected from these compounds or a salt selected from their salts. These compounds may be used either one by one or in a combination of two or more.

According to an aspect of the invention, when the reaction liquid contains an acidic substance, the reaction liquid has preferably a pH of 1 to 6, more preferably a pH of 2 to 5, and further preferably a pH of 3 to 5.

Examples of the above-described polyvalent metal salt include a salt of an alkaline earth metal in the Group 2 of the periodic table (e.g., magnesium, calcium), a salt of a transition metal in the Group 3 of the periodic table (e.g., lanthanum), a salt of a cation from the Group 13 of the periodic table (e.g., aluminium), and a salt of lanthanides (e.g., neodymium). The salts of these metals are preferably carboxylic salts (e.g., formic acid salt, acetic acid salt, benzoic acid salt), nitric acid salts, chloride salts, or thiocyanic acid salts. Among them, a calcium salt or a magnesium salt of carboxylic acid (e.g., formic acid, acetic acid, benzoic acid), a calcium salt or a magnesium salt of nitric acid, calcium chloride, magnesium chloride, or a calcium salt or a magnesium salt of thiocyanic acid is preferable.

The above reactants may be used either solely or in a mixture of two or more.

The content of the reactant in the reaction liquid for producing aggregates in the ink composition is preferably in the range of 1 to 20 mass %, more preferably 1.5 to 15 mass %, further preferably 2 to 10 mass %.

The water-soluble organic solvents, surfactants, and other additives which can be contained in the reaction liquid according to an aspect of the invention are the same as those of the ink composition to be described below.

The reaction liquid according to an aspect of the invention contains preferably an anionic surfactant having at least one of a carboxyl group or a phosphoric acid group 0.1 to 10 mass %, and a reactant having at least one of a polyvalent metal salt and acidic substance 1 to 20 mass %; more preferably a fluoric surfactant having at least one of a carboxyl group or a phosphonic acid group 0.1 to 10 mass % as an anionic surfactant, and an acidic substance 1 to 20 mass % as a reactant; and further preferably ZONYL UR 0.1 to 10 mass % as an anionic surfactant, and a citric acid 1 to 20 mass % as a reactant; from the viewpoints of occurrence inhibition of curl and cockle, and ink aggregability.

As for the water-soluble organic solvents and other additives which can form the reaction liquid according to an aspect of the invention, the same as those of the ink composition to be described below can be suitably used.

<Ink Composition>

The ink composition (hereinafter, may also be referred to simply as “ink”) according to an aspect of the invention includes at least one colorant, at least one type of resin microparticles, and at least one water-soluble organic solvent, and water, and further may include other components such as a surfactant, if necessary.

The inks according to an aspect of the invention can be used for forming a full-color image. A magenta color tone ink, a cyan color tone ink, and a yellow color tone ink can be used to form a full-color image. Further, a black color tone ink can be used to coordinate color tone. The other inks such as red, green, blue, and white inks, and what has been referred to as “special ink” in the printing field can be used in addition to the yellow, magenta, and cyan color tone inks

Hereinafter, components of the inks will be described in detail.

(Colorant)

As the colorants to be used according to an aspect of the invention, water dispersible pigments are preferable. The water dispersible pigments are not limited as long as they have a function to form an image by coloring, and dye stuff and coloring microparticles also can be used.

Specific examples of the water dispersible pigments include the following (1) to (4) pigments.

(1) Encapsulated pigment: that is, a polymer dispersion in which a pigment is contained in polymer fine particles, and more specifically, the pigment is enabled to be dispersed in water by covering the pigment with a hydrophilic and water-insoluble resin to give hydrophilicity to its resin layer at the surface of the pigment.

(2) Self-dispersing pigment: that is, a pigment which has at least one hydrophilic group at the surface, and has either of water dispersibility or water solubility in the absence of dispersant, and more specifically, carbon black, as a main example, is given hydrophilicity by surface oxidation treatment so that the pigment elemental substance can be dispersed in water.

(3) Resin dispersion pigment: that is, a pigment which is dispersed with a water-soluble high-molecular compound having a weight-average molecular weight of 50,000 (Mw) or less.

(4) Surfactant dispersion pigment: that is, a pigment which is dispersed with a surfactant.

Among them, preferable examples include (1) encapsulated pigment and (2) self-dispersing pigment, and particularly preferable examples include (1) encapsulated pigment.

The microencapsulated pigment will be described here in detail. Preferably the microencapsulated pigment resin is, though not limited to, a high-molecular compound having self-dispersibility or dissolubility in a mixed solvent of water and a water-soluble organic solvent and having an anionic group (acidic property). Typically, the number average molecular weight of the resin is preferably in the range of 1,000 to 100,000 approximately, and particularly preferably in the range of 3,000 to 50,000 approximately. The resin is desirably dissolved in an organic solvent to be a liquid solution. Since the number average molecular weight of the resin is in the above-described range, function as a covering film in the pigment or as a coating film in the ink composition can be fulfilled. The resin is preferably used as a salt of an alkali metal or a salt of an organic amine.

Specific examples of the microencapsulated pigment resin include thermoplastic, thermosetting, or thermal denaturating material having an anionic group such as a high polymer compound of an acrylic, an epoxy, a polyurethane, a polyether, a polyamide, an unsaturated polyester, a phenol, a silicone, or a fluorine series; a polyvinyl series resin such as vinyl chloride, vinyl acetate, polyvinyl alcohol, or polyvinyl butyral; a polyester series resin such as an alkyd resin or a phthalic acid resin; and an amino series material such as a melamine resin, a melamine formaldehyde resin, an amino-alkyd co-condensation resin or a urea resin; or a copolymer or a mixture of these materials.

Among the above resins, an anionic acrylic resin can be obtained by, for example, polymerizing acrylic monomers each of which has an anionic group (hereinafter, referred to as “anionic group-containing acrylic monomer”) in a solvent, or, if necessary, by copolymerizing an acrylic monomer with another monomer which can be copolymerized with the above monomers in a solvent. Examples of the anionic group-containing acrylic monomer include an acrylic monomer having at least one anionic group selected from the group consisting of a carboxyl group, a sulfonic acid group, and a phosphonic group. Among them, an acrylic monomer having a carboxyl group is particularly preferable.

Specific examples of the acrylic monomer having a carboxyl group include acrylic acid, methacrylic acid, crotonic acid, ethacrylic acid, propylacrylic acid, isopropylacrylic acid, itaconic acid, and fumaric acid. Among them, acrylic acid or a methacrylic acid is preferable.

The microencapsulated pigment can be produced using the above components by a conventional physical method or chemical method. According to a preferred embodiment of the invention, the microencapsulated pigment can be produced by a method disclosed in JP-A Nos. 9-151342, 10-140065, 11-209672, 11-172180, 10-25440, or 11-43636.

According to an aspect of the invention, the self-dispersing pigment may also be included in the preferable examples. The self-dispersing pigment is a pigment capable of dispersing in an aqueous vehicle without dispersant where surface of the pigment is bound with a great number of a hydrophilic functional group and/or a salt of them (hereinafter, referred to as “dispersibility providing group”) directly or through a group such as an alkyl group, an alkyl ether group, or an aryl group. In this regard, “dispersing in an aqueous vehicle without dispersant” means a dispersible state even though using no dispersing agent to disperse pigments.

Since the ink which contains a self-dispersing pigment as colorant is not required to contain the above-described dispersant which is commonly contained in ink to disperse pigments, almost no foam caused by deterioration in antifoaming capability attributable to dispersant is formed, thereby facilitating preparation of ink with excellent ejection stability.

Examples of the dispersibility providing group which is bound to the surface of the self-dispersing pigment include —COOH, —CO, —OH, —SO₃H, —PO₃H₂, quaternary ammonium, and/or a salt of them. These can be produced by giving a physical treatment or a chemical treatment to a pigment as material to bind (graft) a dispersibility providing group or an active group having a dispersibility providing group to the surface of the pigment. Examples of the physical treatment include a vacuum plasma treatment. Examples of the chemical treatment include a wet oxidation method to oxidize the surface of the pigment in water by an oxidant and a method to bind a carboxyl group through a phenyl group by binding p-aminobenzoic acid to the surface of the pigment.

According to an aspect of the invention, a self-dispersing pigment which is provided with a surface treatment by an oxidation treatment using a hypohalous acid and/or a hypohalous acid salt, or an oxidation treatment using ozone may be included in the preferable examples. Commercialized products can also be used as the self-dispersing pigment, such as Micro Jet CW-1 (trade name, manufactured by Orient Chemical Industries, Ltd.), CAB-O-JET 200 and CAB-O-JET 300 (these are trade names for a self-dispersing pigment, manufactured by CABOT Corporation) may be included in the examples.

˜Pigment˜

Pigments to be used according to an aspect of the invention are not particularly limited, and they can be selected suitably in accordance with the purposes, for example, either organic pigments or inorganic pigments can be used.

Examples of the organic pigment include an azo pigment, a polycyclic pigment, a dye chelate, a nitro pigment, a nitroso pigment, and aniline black. Among them, an azo pigment, a polycyclic pigment and the like are preferable. Examples of the azo pigment include an azo lake, an insoluble azo pigment, a condensed azo pigment, and a chelate azo pigment. Examples of the polycyclic pigment include a phthalocyanine pigment, a perylene pigment, a perynon pigment, an anthraquinone pigment, a quinacridone pigment, a dioxazine pigment, an indigo pigment, a thioindigo pigment, an isoindolinone pigment, and a quinophlalone pigment. Examples of the dye chelate include a basic dye type chelate and an acidic dye type chelate.

Examples of the inorganic pigment include titanium oxide, iron oxide, calcium carbonate, barium sulfate, aluminum hydroxide, barium yellow, cadmium red, chrome yellow, and carbon black. Among them, carbon black is particularly preferable. In this regard, the carbon black may be produced by a know method such as a contact method, a furnace method, and a thermal method.

As a black color series, specific examples of the carbon black include, though not limited to, Raven 7000, Raven 5750, Raven 5250, Raven 5000 ULTRA II, Raven 3500, Raven 2000, Raven 1500, Raven 1250, Raven 1200, Raven 1190 ULTRA II, Raven 1170, Raven 1255, Raven 1080, Raven 1060, and Raven 700 (these are trade names, manufactured by Columbian Carbon Co., Ltd.); Regal 400R, Regal 330R, Regal 660R, Mogul L, Black Pearls L, Monarch 700, Monarch 800, Monarch 880, Monarch 900, Monarch 1000, Monarch 1100, Monarch 1300, and Monarch 1400 (these are trade names, manufactured by Cabot Corporation); Color Black FW1, Color Black FW2, Color Black FW2V, Color Black 18, Color Black FW200, Color Black S150, Color Black S160, Color Black S170, Printex 35, Printex U, Printex V, Printex 140U, Printex 140V, Special Black 6, Special Black 5, Special Black 4A, and Special Black 4 (these are trade names, manufactured by Evonik Industries, former “Degussa”); No. 25, No. 33, No. 40, No. 45, No. 47, No. 52, No. 900, No. 2200B, No. 2300, MCF-88, MA 600, MA 7, MA 8, and MA 100 (these are trade names, manufactured by Mitsubishi Chemical Corporation).

As the usable organic pigments according to an aspect of the invention, examples of the yellow ink pigments include C.I. Pigment Yellow 1, 2, 3, 4, 5, 6, 7, 10, 11, 12, 13, 14, 14C, 16, 17, 24, 34, 35, 37, 42, 53, 55, 65, 73, 74, 75, 81, 83, 93, 95, 97, 98, 100, 101, 104, 108, 109, 110, 114, 117, 120, 128, 129, 138, 150, 151, 153, 154, 155, and 180.

Examples of the magenta ink pigments include C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 48 (Ca), 48 (Mn), 48:2, 48:3, 48:4, 49, 49:1, 50, 51, 52, 52:2, 53:1, 53, 55, 57 (Ca), 57:1, 60, 60:1, 63:1, 63:2, 64, 64:1, 81, 83, 87, 88, 89, 90, 101 (Colcothar), 104, 105, 106, 108 (Cadmium Red), 112, 114, 122 (Quinacridone Magenta), 123, 146, 149, 163, 166, 168, 170, 172, 177, 178, 179, 184, 185, 190, 193, 202, 209, 219, and 269; and C.I. Pigment Violet 19; where C.I. Pigment Red 122 is particularly preferable.

Examples of the cyan ink pigments include C.I. Pigment Blue 1, 2, 3, 15, 15:1, 15:2, 15:3, 15:34, 16, 17:1, 22, 25, 56, and 60; C.I. Bat Blue 4, 60, and 63; where C.I. Pigment Blue 15:3 is particularly preferable.

The above pigments can be used either solely or in a combination of two or more selected from each of the above groups or among the groups.

˜Dispersant˜

According to an aspect of the invention, a nonionic compound, an anionic compound, a cationic compound, an amphoteric compound and the like can be used as dispersant for the encapsulated pigment or the resin dispersion pigment.

For example, a copolymer of monomers each of which has an α,β-ethylenically unsaturated group is included in the above compounds. Examples of the monomer having an α,β-ethylenically unsaturated group include ethylene, propylene, butene, pentene, hexene, vinyl acetate, allyl acetate, acrylic acid, methacrylic acid, crotonic acid, crotonic acid ester, itaconic acid, itaconic acid monoester, maleic acid, maleic acid monoester, maleic acid diester, fumaric acid, fumaric acid monoester, vinylsulfonic acid, styrenesulfonic acid, sulfonated vinylnaphthalene, vinyl alcohol, acrylamide, methacryloxyethyl phosphate, bis-methacryloxyethyl phosphate, methacryloxyethyl phenyl acid phosphate, ethylene glycol dimethacrylate, diethylene glycol dimethacrylate, styrene, α-methylstyrene, a styrene derivative such as vinyltoluene, vinylcyclohexane, vinylnaphthalene, a vinylnaphthalene derivative, an aromatic group-substitutable acrylic acid alkyl ester, acrylic acid phenyl ester, an aromatic group-substitutable methacrylic acid alkyl ester, methacrylic acid phenyl ester, methacrylic acid cycloalkyl ester, crotonic acid alkyl ester, itaconic acid dialkyl ester, maleic acid dialkyl ester, vinyl alcohol, and/or a derivative of these compounds.

A polymer or copolymer obtained by polymerizing one of the above monomers, or by copolymerizing a plurality of the above monomers, each of which has an α,β-ethylenically unsaturated group, is used as a high-polymer dispersant. Specific examples of the above high-polymer include an acrylic acid alkyl ester-acrylic acid copolymer, a methacrylic acid alkyl ester-methacrylic acid copolymer, a styrene-acrylic acid alkyl ester-acrylic acid copolymer, a styrene-methacrylic acid phenyl ester-methacrylic acid copolymer, a styrene-methacrylic acid cyclohexyl ester-methacrylic acid copolymer, a styrene-styrenesulfonic acid copolymer, a styrene-maleic acid copolymer, a styrene-methacrylic acid copolymer, a styrene-acrylic acid copolymer, a vinylnaphthalene-maleic acid copolymer, a vinylnaphthalene-methacrylic acid copolymer, a vinylnaphthalene-acrylic acid copolymer, polystyrene, polyester, and polyvinyl alcohol.

The weight-average molecular weight of the dispersant according to an aspect of the invention is preferably 2,000 to 60,000 (Mw). The addition amount ratio of the dispersant to a pigment according to an aspect of the invention is preferably in the range of 10% to 100%, more preferably 20% to 70%, and further preferably 40% to 50%, on a mass basis.

(Water-Soluble Organic Solvent)

In aqueous ink of the inkjet recording system, a water-soluble organic solvent may be used for serving as a drying inhibitor, a humectant, or a penetration enhancer.

The drying inhibitor is used for preventing clogging at the ink ejecting nozzle caused by drying of the inkjet ink, and the vapor pressure of the water-soluble organic solvent is preferably lower than water as a drying inhibitor or a humectant.

The water-soluble organic solvent is also advantageously used for the purpose of penetration of inkjet ink into a paper sheet as a penetration enhancer.

Examples of the water-soluble organic solvent include alkane diols (polyhydric alcohols) such as glycerin, 1,2,6-hexanetriol, trimethylolpropane, ethylene glycol, propylene glycol, diethylene glycol, triethylene glycol, tetraethylene glycol, pentaethylene glycol, dipropylene glycol, 2-butene-1,4-diol, 2-ethyl-1,3-hexanediol, 2-methyl-2,4-pentanediol, 1,2-octanediol, 1,2-hexanediol, 1,2-pentanediol, and 4-methyl-1,2-pentanediol; saccharides such as glucose, mannose, fructose, ribose, xylose, arabinose, galactose, aldonic acid, glucitol, maltose, cellobiose, lactose, sucrose, trehalose, and maltotriose; sugar alcohols; hyaluronic acids; so-called solid humectant such as ureas; alkyl alcohols having 1 to 4 carbon atoms such as ethanol, methanol, butanol, propanol, and isopropanol; glycol ethers such as ethylene glycol monomethyl ether, ethylene glycol monoethyl ether, ethylene glycol monobutyl ether, ethylene glycol monomethyl ether acetate, diethylene glycol monomethyl ether, diethylene glycol monoethyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-t-butyl ether, 1-methyl-1-methoxybutanol, propylene glycol monomethyl ether, propylene glycol monoethyl ether, propylene glycol mono-t-butyl ether, propylene glycol mono-n-propyl ether, propylene glycol mono-iso-propyl ether, dipropylene glycol monomethyl ether, dipropylene glycol monoethyl ether, dipropylene glycol mono-n-propyl ether, and dipropylene glycol mono-iso-propyl ether; 2-pyrrolidone, N-methyl-2-pyrrolidone, 1,3-dimethyl-2-imidazolidinone, formamide, acetamide, dimethyl sulfoxide, sorbit, sorbitan, acetine, diacetine, triacetine, and sulfolane; where one of or two or more of the above can be used.

For the purpose of serving as a drying inhibitor or a humectant, polyhydric alcohols are useful, for example, glycerin, ethylene glycol, diethylene glycol, triethylene glycol, propylene glycol, dipropylene glycol, tripropylene glycol, 1,3-butanediol, 2,3-butanediol, 1,4-butanediol, 3-methyl-1,3-butanediol, 1,5-pentanediol, tetraethylene glycol, 1,6-hexanediol, 2-methyl-2,4-pentanediol, polyethylene glycol, 1,2,4-butanetriol, and 1,2,6-hexanetriol. These may be used either solely or in a combination of two or more.

For the purpose of serving as a penetrant, polyol compounds are preferable, and examples of aliphatic diols include 2,2,4-trimethyl-1,3-pentanediol, 2-ethyl-2-methyl-1,3-propanediol, 3,3-dimethyl-1,2-butanediol, 2,2-diethyl-1,3-propanediol, 2-methyl-2-propyl-1,3-propanediol, 2,4-dimethyl-2,4-pentanediol, 2,5-dimethyl-2,5-hexanediol, 5-hexene-1,2-diol, and 2-ethyl-1,3-hexanediol. Among them, 2-ethyl-1,3-hexanediol and 2,2,4-trimethyl-1,3-pentanediol may be included in the preferable examples.

The water-soluble organic solvents to be used for the ink according to an aspect of the invention may be used either solely or in a combination of two or more. The content of the water-soluble organic solvent may be 1 mass % to 60 mass %, and preferably 5 mass % to 40 mass %.

The addition amount of water to be used for the ink according to an aspect of the invention is, though not particularly limited to, preferably 10 mass % to 99 mass %, more preferably 30 mass % to 80 mass %, and further preferably 50 mass % to 70 mass %.

(Resin Microparticle)

The ink composition according to an aspect of the invention includes at least one type of resin microparticles. By containing resin microparticles, scratch resistance of formed images can be improved.

Examples of the resin microparticles or polymer latex to be used according to an aspect of the invention include an acrylic resin, a vinyl acetate resin, a styrene-butadiene resin, a vinyl chloride resin, an acryl-styrene resin, a butadiene resin, a styrene resin, a cross-linked acrylic resin, a cross-linked styrene resin, benzoguanamine resin, phenolic resin, silicone resin, epoxy resin, urethane resin, paraffinic resin, and fluoric resin. Preferable examples include an acrylic resin, an acryl-styrene resin, a styrene resin, a cross-linked acrylic resin, and a cross-linked styrene resin.

The weight-average molecular weight of the resin microparticles is preferably 10,000 to 200,000, and more preferably 100,000 to 200,000 (Mw).

The average particle diameter of the resin microparticles is preferably in the range of 10 nm to 1 μm, more preferably in the range of 10 to 200 nm, further preferably in the range of 20 to 100 nm, and particularly preferably in the range of 20 to 50 nm.

The content ratio of the resin microparticles to ink is preferably 0.5 to 20 mass %, more preferably 3 to 20 mass %, and further preferably 5 to 15 mass %.

The glass transition temperature (Tg) of the resin microparticles is preferably at least 30° C., more preferably at least 40° C., and further preferably at least 50° C.

The particle size distribution of the polymer particles is not particularly limited, and, for example, either of polymer particles with a wide particle size distribution or with a monodisperse particle size distribution may be used. In addition, a mixture of two or more types of polymer fine particles with a monodisperse particle size distribution also may be used.

(Surfactant)

The ink according to an aspect of the invention may contain a surfactant if necessary, and the surfactant can be used as a surface tension adjuster.

Examples of the surface tension adjuster include a nonionic, a cationic, an anionic, and a betaine surfactant. The addition amount of the surface tension adjuster, that is, the amount to adjust the surface tension of the ink according to an aspect of the invention for ejecting droplets excellently by inkjet, is preferably the amount capable of adjusting the ink surface tension to 20 to 60 mN/m, more preferably the amount capable of adjusting the ink surface tension to 20 to 45 mN/m, and further preferably the amount capable of adjusting the ink surface tension to 25 to 40 mN/m.

As for the surfactant according to an aspect of the invention, for example, a compound with a structure having a hydrophilic portion and a hydrophobic portion in combination within the molecule can be used effectively, and any of an anionic surfactant, a cationic surfactant, an amphoteric surfactant, and a nonionic surfactant can be used. Further, any of the above-described high-molecular substances (high-macromolecular dispersants) can be used as a surfactant.

Specific examples of the anionic surfactant include sodium dodecylbenzene sulfonate, sodium lauryl sulfate, sodium alkyl diphenyl ether disulfonate, sodium naphthalene sulfonate, sodium dialkyl sulfosuccinate, sodium stearate, potassium oleate, sodium dioctyl sulfosuccinate, sodium polyoxyethylene alkyl ether sulfate, sodium polyoxyethylene alkylphenyl ether sulfate, sodium oleate, and sodium t-octyl phenoxy ethoxy polyethoxy ethyl sulfate salt; where one of or two or more of the above can be selected.

Specific examples of the nonionic surfactant include polyoxyethylene lauryl ether, polyoxyethylene octyl phenyl ether, polyoxyethylene oleyl phenyl ether, polyoxyethylene nonyl phenyl ether, oxyethylene-oxypropylene block copolymer, and t-octyl phenoxy ethyl polyethoxy ethanol, and nonyl phenoxy ethyl polyethoxy ethanol; where one of or two or more of the above can be selected.

Examples of the cationic surfactant include a tetraalkyl ammonium salt, an alkyl amine salt, a benzalkonium salt, an alkyl pyridinium salt, and an imidazolium salt; and specific examples include dihydroxyethyl stearylamine, 2-heptadecenyl-hydroxyethyl imidazoline, lauryl dimethylbenzylammonium chloride, cetylpyridinium chloride, and stearamide methylpyridinium chloride.

The content ratio of the surfactant of the ink composition according to an aspect of the invention is, though not particularly limited to, preferably at least 1 mass %, more preferably 1 to 10 mass %, further preferably 1 to 3 mass %.

(Other Components)

The ink composition according to an aspect of the invention may contain various additives as the other components, if necessary.

Examples of the other additives include known additives such as ultraviolet absorbents, fading preventing agents, fungicides, pH adjusters, antirust agents, antioxidants, emulsion stabilizers, preservatives, antifoaming agents, viscosity adjusters, dispersion stabilizers, and chelating agents.

Examples of the ultraviolet absorbents include, benzophenone ultraviolet absorbents, benzotriazole ultraviolet absorbents, salicylate ultraviolet absorbents, cyanoacrylate ultraviolet absorbents, and nickelic complex salt ultraviolet absorbents.

As for the fading preventing agents, a variety of organic and metal complex fading preventing agents can be used. Examples of the organic fading preventing agents include hydroquinones, alkoxyphenols, dialkoxyphenols, phenols, anilines, amines, indanes, chromans, alkoxyanilines, and hetero rings. Examples of the metal complexes include nickel complexes and zinc complexes.

Examples of the antifungal agents include sodium dehydroacetate, sodium benzoate, sodium pyridinethione-1-oxide, ethyl p-hyroxybenzoate, and 1,2-benzisothiazoline-3-one, sodium sorbate, and sodium pentachlorophenol. These are used in ink preferably 0.02 mass % to 1.00 mass %.

The pH adjusters are not particularly limited as long as the pH adjusters are capable of adjusting pH to an intended value without causing a negative effect on the recording ink to be prepared, and they can be selected suitably in accordance with the purpose. Examples of the pH adjusters include alcoholic amines (e.g, diethanolamine, triethanolamine, 2-amino-2-ethyl-1,3-propanediol), alkali metal hydroxides (e.g, lithium hydroxide, sodium hydroxide, potassium hydroxide), ammonium hydroxides (e.g, ammonium hydroxide, quaternary ammonium hydroxide), phosphonium hydroxides, and alkali metal carbonates.

Examples of the antirust agents include acidic sulfite salt, sodium thiosulfate, ammonium thioglycolate, diisopropyl ammonium nitrite, pentaerythritol tetranitrate, and dicyclohexyl ammonium nitrite.

Examples of the antioxidants include phenolic antioxidants (including hindered phenol antioxidants), amine antioxidants, sulfuric antioxidants, and phosphorus antioxidants.

Examples of the chelating agents include sodium ethylenediamine tetraacetate, sodium nitrilo triacetate, sodium hydroxyethyl ethylenediamine triacetate, sodium diethylenetriamine pentaacetate, and sodium uramil diacetate.

<Physical Properties of Ink>

The surface tension of the ink according to an aspect of the invention is preferably 20 mN/m to 60 mN/m, more preferably 20 mN/m to 45 mN/m, and further preferably 25 mN/m to 40 mN/m.

The viscosity at a temperature of 20° C. of the ink according to an aspect of the invention is preferably at least 1.2 mPa·s and no more than 15.0 mPa·s, more preferably at least 2 mPa·s and less than 13 mPa·s, and further preferably at least 2.5 mPa·s and less than 10 mPa·s.

[Image Forming Method]

The image recording method according to an aspect of the invention includes a reaction liquid applying step, wherein a reaction liquid, which contains a reactant for producing aggregates by contacting with an ink composition, at least one anionic surfactant, a water-soluble organic solvent, and water, is applied on a recording medium; and an ink applying step, wherein the ink composition, which contains a colorant, resin microparticles, a water-soluble organic solvent, and water, is applied on the recording medium on which the reaction liquid is applied in advance.

By applying the reaction liquid which contains the anionic surfactant in advance of applying the ink composition, occurrence of curl and cockle can be inhibited effectively.

The image recording method according to an aspect of the invention may also include other steps, if necessary.

<Reaction Liquid Applying Step>

According to an aspect of the invention, known liquids applying methods can be used for applying the above-described reaction liquid without particular limitations, and either of application with an inkjet system to be described below or application with an application roller and the like may be adopted. Either of full application on the whole of the recording medium or partial application on the area where inkjet recording is to be performed may be adopted. However, according to an aspect of the invention, partial application on the area where inkjet recording is to be performed is preferable, from the viewpoint of glossiness of non-image area.

In the reaction liquid applying step according to an aspect of the invention, the reaction liquid in the above ink set can be advantageously used.

The reaction liquid applying step according to an aspect of the invention preferably includes a drying removal step additionally after applying the reaction liquid. By drying and removing the solvent contained in the reaction liquid after applying the reaction liquid, occurrence of curl and cockle can be inhibited effectively, and image forming can be performed more excellently.

The above drying removal step is not particularly limited, as long as the water and water-soluble organic solvent contained in the reaction liquid can be removed at least partially. For example, drying can be performed by heating or dry-air blowing.

In the image recording method according to an aspect of the invention, the water contact angle of the recording medium on which the reaction liquid is applied in advance is preferably at least 75 degrees, and more preferably at least 80 degrees. By obtaining at least 75 degrees of water contact angle, penetration of water contained in the ink composition can be inhibited more effectively, and occurrence of curl and cockle can be inhibited more advantageously.

The water contact angle of the recording medium on which the reaction liquid is applied according to an aspect of the invention is specifically the water contact angle of the recording medium which has been subjected to drying after application of the reaction liquid.

The water contact angle was measured in the manner that 1.0 μl of water was added dropwise to a recording medium on which a reaction liquid had been applied in advance, and the water contact angle was measured after a lapse of 0.30 seconds using a DropMaster DM700 (trade name, manufactured by Kyowa Interface Science Co., Ltd.) as a measurement device.

According to an aspect of the invention, examples of the method for adjusting the water contact angle to at least 75 degrees include a method of increasing the content ratio (e.g., at least 1.0 mass %) of an anionic surfactant in the reaction liquid and a method of adopting a fluoric surfactant (e.g., ZONYL UR) as an anionic surfactant.

As for the application amount of the reaction liquid in the reaction liquid applying step according to an aspect of the invention, the application amount of the anionic surfactant is preferably 0.05 to 0.5 g/m², and more preferably 0.1 to 0.4 g/m², from the viewpoints of occurrence inhibition of curl and cockle, and image formability.

<Ink Applying Step>

The image recording method according to an aspect of the invention includes an ink applying step, wherein at least one ink composition, which contains a colorant, resin microparticles, a water-soluble organic solvent, and water, is applied on the recording medium on which the reaction liquid is applied in advance. By applying the ink composition on the recording medium on which the reaction liquid is applied in advance, occurrence of curl and cockle can be inhibited effectively, and excellent images can be formed.

In the ink applying step according to an aspect of the invention, the ink composition is preferably applied by the inkjet recording method to be described below, from the viewpoint of image formability.

(Inkjet Recording Method)

In a preferable inkjet recording method according to an aspect of the invention, an inkjet recording ink is provided with energy to form images on a known image receiving material, that is, plain paper, resin coated paper, inkjet special paper which is disclosed in JP-A Nos. 8-169172, 8-27693, 2-276670, 7-276789, 9-323475, 62-238783, 10-153989, 10-217473, 10-235995, 10-337947, 10-217597, and 10-337947, film, electrophotographic general-purpose paper, cloth, glass, metals, or ceramics. A disclosure in paragraphs 0093 to 0105 in JP-A No. 2003-306623 can be applied to a desirable inkjet recording method according to an aspect of the invention.

For the purpose of providing glossiness and water resistance properties, or for improving weather resistance in forming images, polymer latex compounds may be used. The timing of applying a latex compound to the receiving material may be any of before, after, and at the same time as application of a colorant, and accordingly, the place to be applied with the latex compound may be either in the receiving paper or in the ink, or the latex compound may be used as a single independent polymer latex liquid. Specifically, the JP-A Nos. 2002-166638, 2002-121440, 2002-154201, 2002-144696, and 2002-080759 may be suitably adopted.

The image recording method according to an aspect of the invention includes at least:

The first step: applying a reaction liquid which contains at least one reactant for producing aggregates by contacting with an ink composition and at least one anionic surfactant to be applied on a recording medium; and
The second step: applying an ink composition which contains a colorant, resin microparticles, a water-soluble organic solvent, and water to be applied on a recording medium on which the reaction liquid is applied in advance.
In addition to the above, other steps may also be included, if necessary.

(Other Steps)

The other steps are not particularly limited, and can be selected suitably in accordance with the purpose. Examples of the other steps include a drying removal step and a heating fixation step.

The drying removal step (hereinafter, may also be referred to simply as “drying step”) is not particularly limited, as long as the solvent contained in a pretreatment liquid, reaction liquid, ink composition and the like can be dried and removed at least partially, and the drying removal step can be performed by a common method such as air-blow and heating.

The above drying removal step may be provided at, for example, either of the following timings:

(1) After the reaction liquid applying step and before the ink composition applying step.
(2) After the ink composition applying step.

According to an aspect of the invention, the drying removal step is preferably provided at least (1) after the reaction liquid applying step and before the ink composition applying step, and more preferably provided (3) additionally after the ink composition applying step, from the viewpoint of inhibition of the occurrence of curl and cockle.

The heating fixation step according to an aspect of the invention is not particularly limited as long as the resin microparticles in the ink used in the above-described inkjet recording method can be melted and fixated, and can be selected suitably in accordance with the purpose.

<Recording Medium>

The recording medium to be used according to an aspect of the invention is not particularly limited, and general printing paper made mostly from cellulose, for example, so-called high-grade paper, coated paper, and art paper which are used in general offset printing and the like can be used. When forming images using general aqueous inkjet, solvent (such as water and hydrophilic organic solvent) of the aqueous ink may cause curl of the general printing paper made mostly from cellulose, and that may cause serious problems in quality. In contrast, occurrence of curl can be inhibited when forming images by the image forming method according to an aspect of the invention.

As the recording medium for the image recording method according to an aspect of the invention, products sold on the open market may be used by selecting suitably. For example, high-grade paper (A) such as “OK Prince High-quality” (trade name, manufactured by Oji Paper Co., Ltd.), “Shiorai” (trade name, manufactured by Nippon Paper Group, Inc.), and “New NPi Form High-quality” (trade name, manufactured by Nippon Paper Group, Inc.); fine coated paper such as “OK Ever Light Coated” (trade name, manufactured by Oji Paper Co., Ltd.) and “AURORA-S” (trade name, manufactured by Nippon Paper Group, Inc.); light-weight coated paper (A3) such as “OK Coat L” (trade name, manufactured by Oji Paper Co., Ltd.) and “AURORA-L” (trade name, manufactured by Nippon Paper Group, Inc.); coated paper (A2, B2) such as “OK Top Coat Plus” (trade name, manufactured by Oji Paper Co., Ltd.) and “AURORA Coat” (trade name, manufactured by Nippon Paper Group, Inc.); art paper (A1) such as “OK Kanefuji (Golden Cask) Plus” (trade name, manufactured by Oji Paper Co., Ltd.) and “Tokubishi Art” (trade name, manufactured by Mitsubishi Paper Mills Limited.); and various types of photo paper for inkjet recording.

### EXAMPLES

Hereinafter, the present invention will be described more specifically in accordance with Examples. However, it will be understood that the invention is not in any way restricted to these Examples. The “parts” and “%” are represented on a mass basis, unless otherwise noted.

<Ink Formulation>

### (1) Formulation of Cyan Pigment Ink C

### (Preparation of the Pigment Dispersion)

First, 10 g of Cyanine Blue A-22: PB 15:3 (trade name, manufactured by Dainichiseika Color & Chemicals Mfg. Co., Ltd.) as a colorant, 10.0 g of the low-molecular-weight dispersant 2-1, 4.0 g of glycerin, and 26 g of ion-exchange water were mixed by stirring to prepare a roughly dispersed liquid. Then, the roughly dispersed liquid was intermittently irradiated (irradiation: 0.5 sec., pause: 1.0 sec.) with ultrasonic waves by using an ultrasonic irradiation device, Ultrasonic Processor, Vibra-cell VC 750 (trade name, manufactured by Sonics & Materials, Inc.) with tapered microchip (diameter: 5 mm, amplitude: 30%) for 2 hours to have the pigment further dispersed so as to obtain a 20% pigment dispersion liquid. In this regard, the low-molecular-weight dispersant 2-1 is a compound represented by the following chemical formula.

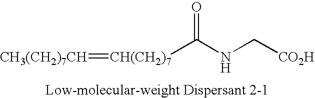

Separately from the above, the following compounds were respectively weighed, and mixed together by stirring to prepare a liquid mixture I.

### (Liquid Mixture I)

| | |
|---|---|
| Glycerin (water-soluble organic solvent) | 4.5 g |
| Diethylene glycol (water-soluble organic solvent) | 10.0 g |
| Orfine E1010 | 1.5 g |
| (trade name, manufactured by Nissin Chemical | |
| Industry Co., Ltd.) | |
| Ion-exchange water | 11.0 g |

The liquid mixture I was gradually added dropwise to 23.0 g of a stirred 44% SBR dispersion liquid (resin microparticles: acrylic acid 3%, Tg—glass transition temperature: 30° C.), and a liquid mixture II was prepared by stirring and mixing.

The obtained liquid mixture II was gradually added dropwise to the above-described 20% pigment dispersion liquid while the liquid was stirred and mixed to prepare a 100 g of cyan pigment ink C (cyan ink) as an ink composition.

The pH value of the pigment ink C was measured using a pH Meter WM-50EG (trade name, manufactured by DKK-TOA Corporation), and the pH value was 8.7.

(2) Formulation of Magenta Pigment Ink M

The magenta pigment ink M (magenta ink) was formulated in a manner similar to that of preparation of the pigment ink C described above other than a pigment that Cromophtal Jet Magenta DMQ: PR-122 (trade name, manufactured by Ciba Specialty Chemicals Inc.) was used instead of Cyanine Blue A-22 which was used as the pigment in preparation of the pigment ink C.

The pH value of the pigment ink M was measured using the pH Meter WM-50EG (trade name, manufactured by DKK-TOA Corporation), and the pH value was 8.6.

(3) Formulation of Yellow Pigment Ink Y

The yellow pigment ink Y (yellow ink) was formulated in a manner similar to that of preparation of the pigment ink C described above other than a pigment that Irgalite Yellow GS: PY74 (trade name, manufactured by Ciba Specialty Chemicals Inc.) was used instead of Cyanine Blue A-22 which was used as the pigment in preparation of the pigment ink C.

The pH value of the pigment ink Y was measured using the pH Meter WM-50EG (trade name, manufactured by DKK-TOA Corporation), and the pH value was 8.4.

(4) Formulation of Black Pigment Ink K

The black pigment ink K (black ink) of black color was formulated in a manner similar to that of preparation of the pigment ink C described above other than a pigment that a dispersing element, CAB-O-JET TM_{—}200: Carbon Black (trade name, manufactured by CABOT Corporation) was used instead of the pigment dispersion liquid which was used as the pigment in preparation of the pigment ink C.

The pH value of the pigment ink K was measured using the pH Meter WM-50EG (trade name, manufactured by DKK-TOA Corporation), and the pH value was 8.5.

<Reaction Liquid Formulation>

(Reaction Liquid 1)

The following materials were mixed to formulate a reaction liquid 1.

| | |
|---|---|
| Phosphoric acid | 10 g |
| Anionic surfactant A | 10 g |
| Diethylene glycol monoethyl ether | 20 g |
| Ion-exchange water | 60 g |

The pH value of the reaction liquid 1 prepared in the above-described manner was measured with the pH Meter WM-50EG (trade name, manufactured by DKK-TOA Corporation), and the pH value was 1.0.

(Reaction Liquid 2)

The following materials were mixed to formulate a reaction liquid 2.

| | |
|---|---|
| Phosphoric acid | 10 g |
| Anionic surfactant B | 3 g |
| Diethylene glycol monomethyl ether | 25 g |
| Ion-exchange water | 62 g |

The pH value of the formulated reaction liquid 2 was measured, and the pH value was 1.0.

(Reaction Liquid 3)

The following materials were mixed to formulate a reaction liquid 3.

| | |
|---|---|
| Phosphoric acid | 10 g |
| Anionic surfactant C | 10 g |
| Diethylene glycol monoethyl ether | 20 g |
| Ion-exchange water | 60 g |

The pH value of the formulated reaction liquid 3 was measured, and the pH value was 1.0.

(Reaction Liquid 4)

The following materials were mixed to formulate a reaction liquid 4.

| | |
|---|---|
| Phosphoric acid | 10 g |
| Anionic surfactant D | 10 g |
| Diethylene glycol monomethyl ether | 25 g |
| Ion-exchange water | 55 g |

The pH value of the formulated reaction liquid 4 was measured, and the pH value was 1.0.

(Reaction Liquid 5)

The following materials were mixed to formulate a reaction liquid 5.

| | |
|---|---|
| Phosphoric acid | 10 g |
| ZONYL UR (anionic surfactant) | 2 g |
| (trade name, manufactured by E. I. du Pont de Nemours | |
| and Company) | |
| Diethylene glycol monoethyl ether | 20 g |
| Ion-exchange water | 68 g |

The pH value of the formulated reaction liquid 5 was measured, and the pH value was 1.0.

(Reaction Liquid 6)

The following materials were mixed to formulate a reaction liquid 6.

| | |
|---|---|
| Phosphoric acid | 10 g |
| ZONYL FSP (anionic surfactant) | 3 g |
| (trade name, manufactured by E. I. du Pont de Nemours | |
| and Company) | |
| Diethylene glycol monomethyl ether | 25 g |
| Ion-exchange water | 62 g |

The pH value of the formulated reaction liquid 6 was measured, and the pH value was 1.0.

(Reaction Liquid 7)

The following materials were mixed to formulate a reaction liquid 7.

| | |
|---|---|
| Phosphoric acid | 10 g |
| Anionic surfactant F | 4 g |
| Diethylene glycol monomethyl ether | 25 g |
| Ion-exchange water | 61 g |

The pH value of the formulated reaction liquid 7 was measured, and the pH value was 1.0.

(Reaction Liquid 8)

The following materials were mixed to formulate a reaction liquid 8.

| | |
|---|---|
| Calcium nitrate | 12 g |
| ZONYL UR (anionic surfactant) | 2 g |
| (trade name, manufactured by E. I. du Pont de Nemours | |
| and Company) | |
| Diethylene glycol monomethyl ether | 23 g |
| Ion-exchange water | 63 g |

The pH value of the formulated reaction liquid 7 was measured, and the pH value was 3.5.

(Reaction Liquid 9)

The following materials were mixed to formulate a reaction liquid 9.

| | |
|---|---|
| Phosphoric acid | 10 g |
| ZONYL UR (anionic surfactant) | 4 g |
| (trade name, manufactured by E. I. du Pont de Nemours | |
| and Company) | |
| Diethylene glycol monoethyl ether | 20 g |
| Ion-exchange water | 66 g |

The pH value of the formulated reaction liquid 9 was measured, and the pH value was 1.0.

(Reaction Liquid 10)

The following materials were mixed to formulate a reaction liquid 10.

| | |
|---|---|
| Phosphoric acid | 10 g |
| Orfine E1010 (nonionic surfactant) | 3 g |
| (trade name, manufactured by Nissin Chemical Industry Co., Ltd.) | |
| Diethylene glycol monomethyl ether | 25 g |
| Ion-exchange water | 64 g |

The pH value of the formulated reaction liquid 10 was measured, and the pH value was 1.0.

(Reaction Liquid 11)

The following materials were mixed to formulate a reaction liquid 11.

| | |
|---|---|
| Phosphoric acid | 10 g |
| Cationic surfactant E | 3 g |
| Diethylene glycol monoethyl ether | 20 g |
| Ion-exchange water | 69 g |

The pH value of the formulated reaction liquid 11 was measured, and the pH value was 1.0.

Structures of the surfactants A to F used in formulation of the above-described reaction liquids are shown below.

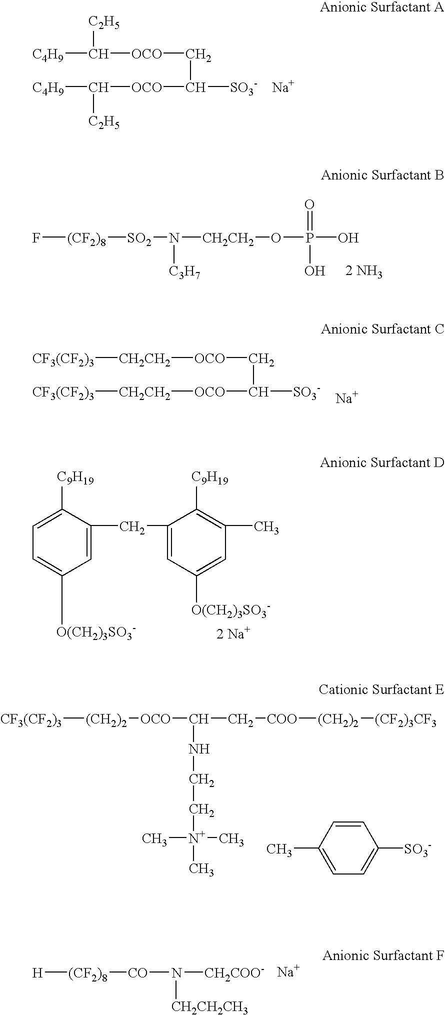

<Image Recording>

Images were recorded using A4 sized matt coated paper, U-Light (trade name, manufactured by Nippon Paper Group, Inc.) as a recording medium in combination with the reaction liquids shown in Table 1, under the following image recording conditions.

<Droplet Ejection System>

Four-color single-pass image formation was performed using the cyan pigment ink C, magenta pigment ink M, yellow pigment ink Y, and black pigment ink K as the ink composition, those were obtained in the above-described manner, and employing the reaction liquids shown in Table 1, under the following conditions.

—Reaction Liquid Applying Step—

Head: piezo full-line head (600 dpi/20 inch width).

Ejection droplet volume: two-value recording at 0 and 4.0 pL.

Drive frequency: 15 kHz (recording medium conveying speed: 635 mm/sec.)

Image drawing pattern: each of the reaction liquids was applied in advance by drawing a pattern corresponding to the position where at least one colored ink would be applied in the ink applying step. Each application amount of the surfactant in the area where the reaction liquid was applied is shown in Table 1.

Each recording medium on which the reaction liquid had been applied was dried under the following conditions.

### —Drying Conditions for Reaction Liquid (Air-Blow Drying)—

Air-blow speed: 15 msec.

Temperature: heat was applied by a contact-type flat heater from the rear surface of the recording medium so that the front surface temperature of the recording medium became 60° C.

Air-blow range: 450 mm (drying time length: 0.7 sec.)

—Ink Applying Step—

The ink composition was applied on each recording medium under the following conditions.

Head: piezo full-line head four-color setting (1,200 dpi/20 inch width).

Ejection droplet volume: four-value recording at 0, 2.0, 3.5, and 4.0 pL

Drive frequency: 30 kHz (recording medium conveying speed: 635 mm/sec.)

Each recording medium was dried under the following conditions.

### —Drying Conditions for Ink (Air-Blow Drying)—

Air-blow speed: 15 msec.

Temperature: heat was applied by a contact-type flat heater from the rear surface of the recording medium so that the front surface temperature of the recording medium became 60° C.

Air-blow range: 640 mm (drying time length: 1.0 sec.)

A heating fixation step was performed under the following conditions.

### —Fixation—

Silicone rubber roller (hardness: 50°, nip width: 5 mm)

Roller temperature: 90° C.

Pressure: 0.8 MPa

<Evaluation>

### —Water Contact Angle—

The water contact angle of the area in the recording medium on which each of the reaction liquids had been applied in advance of ink application was measured in the manner that 1.0 μl of water was added dropwise, and the water contact angle after a lapse of 0.30 seconds was measured using DropMaster DM700 (trade name, manufactured by Kyowa Interface Science Co., Ltd.). The measurement results are shown in Table 1.

—Post-Print Bleeding Test—

Each gray-scale and character images printed for evaluation were evaluated with eyes according to the following evaluation criteria. The evaluation results are shown in Table 1.

### ˜Evaluation Criteria˜

A: neither image bleeding nor color mixing was observed, and a character, “Hawk” with a character size of no larger than 4 pt. could be resolved.

B: neither image bleeding nor color mixing was observed, and a character, “Hawk” with a character size of 5 pt. could be resolved.

C: considerable image bleeding and color mixing were observed, and that was low in practicality.

D: serious bleeding and color mixing were observed, and that was very low in practicality.

Note: The character “Hawk” is a following complicated Japanese character meaning “Hawk”.

[symbol]

—Evaluation of Curl—

As for the recording medium, ink was ejected on each specimen which had been cut to the size of 50 mm×5 mm with respect to each MD or CD direction so that the ink-ejected area was to be 10 g/m². After image formation, a degree of curl was measured after 8 hours of leaving the specimen under 23° C. and 50% RH, in conformity to the curl curvature measurement method defined by JAPPAN TAPPI Paper Pulp Test Method No. 15-2: 2000, and was evaluated according to the following evaluation criteria. The evaluation results are shown in Table 1.

### ˜Evaluation Criteria˜

A: the degree of curl was less than 10°.

B: the degree of curl was no less than 10° and less than 20°.

C: the degree of curl was no less than 20° and less than 30°.

D: the degree of curl was no less than 30°.

—Evaluation of Cockle—

A single color 100% solid image with a size of 2 cm×2 cm was printed in the center of each recording medium which had been cut to the size of a postal card, and the maximum height of waves which occurred just after printing was measured by Laser Displacement Sensor (trade name, manufactured by Keyence Corporation), and was evaluate according to the following evaluation criteria. The evaluation results are shown in Table 1.

### ˜Evaluation Criteria˜

A: the height was no less than 1 mm and less than 2 mm.

B: the height was no less than 2 mm and less than 3 mm.

C: the height was no less than 3 mm.

TABLE 1

| | | Surfactant | | | | | |
|---|---|---|---|---|---|---|---|
| | | | Application | | | | |
| | | | amount | Contact | Evaluation | | |
| | Reaction Liquid | Type | (g/m²) | angle | Curl | Cockle | Bleeding |
| Example 1 | Reaction Liquid 1 | Anionic | 0.50 | 55° | B | B | A |
| Example 2 | Reaction Liquid 2 | Anionic | 0.15 | 107° | A | A | A |
| Example 3 | Reaction Liquid 3 | Anionic | 0.50 | 62° | B | A | A |
| Example 4 | Reaction Liquid 4 | Anionic | 0.50 | 57° | B | A | A |
| Example 5 | Reaction Liquid 5 | Anionic | 0.30 | 109° | A | A | A |
| Example 6 | Reaction Liquid 6 | Anionic | 0.15 | 80° | B | A | A |
| Example 7 | Reaction Liquid 7 | Anionic | 0.20 | 75° | B | A | A |
| Example 8 | Reaction Liquid 8 | Anionic | 0.10 | 109° | A | A | B |
| Example 9 | Reaction Liquid 9 | Anionic | 0.70 | 114° | A | A | B |
| Example 10 | Reaction Liquid 5 | Anionic | 0.06 | 72° | A | A | A |
| Example 11 | Reaction Liquid 5 | Anionic | 0.03 | 69° | B | B | A |
| Comparative | Reaction Liquid 10 | Nonionic | 0.15 | 64° | C | D | A |
| Example 1 | | | | | | | |
| Comparative | Reaction Liquid 11 | Cationic | 0.15 | 60° | C | C | A |
| Example 2 | | | | | | | |

As shown in Table 1, it is understood that occurrence of curl and cockle can be controlled, and images with less bleeding can be formed by adopting the image recording method according to an aspect of the invention.

All publications, patent applications, and technical standards mentioned in this specification are herein incorporated by reference to the same extent as if each individual publication, patent application, or technical standard was specifically and individually indicated to be incorporated by reference.

The invention includes the following embodiments.

<1> An ink set comprising:

an ink composition which comprises a colorant, resin microparticles, a water-soluble organic solvent, and water; and

a reaction liquid which comprises an anionic surfactant and a reactant for producing aggregates by contact with the ink composition.

<2> The ink set according to <1>, wherein the anionic surfactant is a fluoric surfactant.
<3> The ink set according to <1>, wherein the anionic surfactant has at least one of a carboxyl group or a phosphoric acid group.
<4> The ink set according to <1>, wherein a content of the anionic surfactant in the reaction liquid is 0.1 to 10 mass %.
<5> The ink set according to <1>, wherein the reactant is at least one of a polyvalent metal salt or an acidic substance.
<6> The ink set according to <1>, wherein the reactant contains at least one of a polyvalent metal salt or an acidic substance in an amount of 1 to 20 mass %.
<7> The ink set according to <1>, wherein the reactant is phosphoric acid or citric acid.
<8> An image recording method for forming an image using a colored ink composition, the method comprising:

applying, on a recording medium, a reaction liquid, which comprises an anionic surfactant and a reactant for producing aggregates by contact with the ink composition; and

applying, on the recording medium on which the reaction liquid has been applied, the ink composition, which comprises a colorant, resin microparticles, a water-soluble organic solvent, and water.

<9> The image recording method according to <8>, wherein the anionic surfactant is a fluoric surfactant.
<10> The image recording method according to <8>, wherein the anionic surfactant has at least one of a carboxyl group or a phosphoric acid group.
<11> The image recording method according to <8>, wherein an area where the reaction liquid is applied on the recording medium has a contact angle of at least 75 degrees to water.
<12> The image recording method according to <8>, wherein, in the application of the reaction liquid, a content of the anionic surfactant is 0.05 g/m² to 0.5 g/m².
<13> The image recording method according to <8>, wherein a content of the anionic surfactant in the reaction liquid is 0.1 to 10 mass %.
<14> The image recording method according to <8>, wherein the reactant is at least one of a polyvalent metal salt or an acidic substance.
<15> The image recording method according to <8>, wherein the reactant contains at least one of a polyvalent metal salt or an acidic substance in an amount of 1 to 20 mass %.
<16> The image recording method according to <8>, wherein the reactant is phosphoric acid or citric acid.

What is claimed is:

1. An image recording method for forming an image using a colored ink composition, the method comprising:
applying, on a recording medium, a reaction liquid, which comprises an anionic surfactant and a reactant for producing aggregates by contact with the ink composition; and
applying, on the recording medium on which the reaction liquid has been applied, the ink composition, which comprises a colorant, resin microparticles, a water-soluble organic solvent, and water.

2. The image recording method according to claim 1, wherein the anionic surfactant is a fluoric surfactant.

3. The image recording method according to claim 1, wherein the anionic surfactant has at least one of a carboxyl group or a phosphoric acid group.

4. The image recording method according to claim 1, wherein an area where the reaction liquid is applied on the recording medium has a contact angle of at least 75 degrees to water.

5. The image recording method according to claim 1, wherein, in the application of the reaction liquid, a content of the anionic surfactant is 0.05 g/m² to 0.5 g/m².

6. The image recording method according to claim 1, wherein a content of the anionic surfactant in the reaction liquid is 0.1 to 10 mass %.

7. The image recording method according to claim 1, wherein the reactant is at least one of a polyvalent metal salt or an acidic substance.

8. The image recording method according to claim 1, wherein the reactant contains at least one of a polyvalent metal salt or an acidic substance in an amount of 1 to 20 mass %.

9. The image recording method according to claim 1, wherein the reactant is phosphoric acid or citric acid.

10. The image recording method according to claim 1, wherein the anionic surfactant is represented by the following formula (1)
(Cf)—(Y)ₙ: formula (1)
wherein Cf represents a n-valence group having at least three fluorine atoms and at least two carbon atoms; Y represents —COO⁻M⁺, —SO₃⁻M⁺, —OSO₃⁻M⁺, or —OP(═O)(O⁻M⁺)₂; M⁺ represents a hydrogen ion or a cation; and n is 1 or 2.

11. The image recording method according to claim 1, wherein the anionic surfactant is represented by the following formula (2)
Rf-(D)ₜ-Y: formula (2)
wherein Rf represents a fluorine-substituted alkyl group or a fluorine-substituted aryl group having 3 to 30 carbon atoms; D represents a divalent group having 1 to 12 carbon atoms single bonded containing at least one selected from the connecting group consisting of —O—, —COO—, —CON(R₁)—, —SO₂N(R₁)—, and —S—; R₁ represents an alkyl group having 1 to 5 carbon atoms; t is 1 or 2; Y represents —COO⁻M⁺, —SO₃⁻M⁺, —OSO₃⁻M⁺, or —OP(═O)(O⁻M⁺)₂; and M⁺ represents a hydrogen ion or a cation.

12. The image recording method according to claim 1, wherein the recording medium is coated paper.
